(19) United States
(12) Patent Application Publication
(10) Pub. No.: US 2023/0060306 A1
(43) Pub. Date: Mar. 2, 2023

(54) Acquisition and Use of Multi-Platform Portable Non-Fungible Token Credits

(71) Applicant: Disney Enterprises, Inc., Burbank, CA (US)

(72) Inventors: Adam D. Eivy, Vashon, WA (US); Kathartine S. Navarre, Los Angeles, CA (US); Dionysius Mavromatis, Kirkland, WA (US)

(21) Appl. No.: 17/895,932

(22) Filed: Aug. 25, 2022

Related U.S. Application Data
(60) Provisional application No. 63/239,037, filed on Aug. 31, 2021.

(51) Int. Cl. G06Q 20/36; G06Q 30/02

(52) U.S. Cl. CPC G06Q 20/367; G06Q 30/0278

(57) ABSTRACT

According to one exemplary implementation, a system includes a computing platform having processing hardware and a system memory storing a software code. The processing hardware is configured to execute the software code to receive entitlement data identifying a user and a right of the user to receive a multi-platform portable NFT credit, determine, using the entitlement data, one or more valuations associated with the multi-platform portable NFT credit, and execute an assignment of the multi-platform portable NFT credit to the user. The processing hardware is further configured to execute the software code to generate, in a secure digital transaction database accessible to the system and multiple distinct providers, a record of the assignment, wherein the multi-platform portable NFT credit is redeemable by the user from any of the distinct providers.

### RELATED APPLICATIONS

The present application claims the benefit of and priority to a pending Provisional Patent Application Ser. No. 63/239,037 filed on Aug. 31, 2021, and titled “Acquisition and Use of Non-Fungible Token Credits,” which is hereby incorporated fully by reference into the present application.

### BACKGROUND

A consumer wishing to enjoy an entertainment experience must typically pay a fee that is specifically tied to that experience, and is often required to pay a surcharge for enhancements or upgrades to the experience. For example, a concert attendee may be required to purchase a ticket to attend a particular event, and may be required to pay a surcharge for VIP access to the event venue, but is usually prevented from using the purchased ticket or paid surcharge to attend a different event or a different venue. As another example, a subscriber to a streaming content service may pay a basic subscription fee for access to advertising-supported (ad-supported) content, but may have to pay an enhanced subscription fee for access to ad-free content. Moreover, a subscription to one streaming service typically does not allow a consumer to access content provided by another service. In other words, one drawback of conventional access models is that they require a consumer to commit to particular content or to a particular event, thereby undesirably restricting consumer choice. Thus, there is a need in the art for a solution enabling consumers to acquire credits that are redeemable for a variety of different consumption experiences from multiple distinct providers.

### BRIEF DESCRIPTION OF THE DRAWINGS

FIG. 1 shows a diagram of an exemplary system serving as a source of multi-platform portable non-fungible token (NFT) credits, according to one implementation;

FIG. 2 shows a diagram of an exemplary user system configured to mediate acquisition and use of multi-platform portable NFT credits, according to one implementation;

FIG. 3 shows a diagram depicting three exemplary scenarios in which a user can acquire and use multi-platform portable NFT credits, according to one implementation;

FIG. 4 shows a table of exemplary metadata included in a multi-platform portable NFT credit, according to one implementation;

FIG. 5 shows a flowchart describing an exemplary method for providing a multi-platform portable NFT credit to a user, according to one implementation;

FIG. 6A shows a flowchart presenting an exemplary method surrounding redemption of a multi-platform portable NFT credit by a user, according to one implementation; and

FIG. 6B shows a flowchart presenting an exemplary method surrounding transfer by sale, trade, or gift of a multi-platform portable NFT credit to another user, according to one implementation.

### DETAILED DESCRIPTION

The following description contains specific information pertaining to implementations in the present disclosure. One skilled in the art will recognize that the present disclosure may be implemented in a manner different from that specifically discussed herein. The drawings in the present application and their accompanying detailed description are directed to merely exemplary implementations. Unless noted otherwise, like or corresponding elements among the figures may be indicated by like or corresponding reference numerals. Moreover, the drawings and illustrations in the present application are generally not to scale, and are not intended to correspond to actual relative dimensions.

The technology known as a non-fungible token (NFT) allows creators of content, such as individual artists and organizations, to sell ownership rights to a digital asset. A digital asset may be digital media such as photos, videos, audio, and other types of digital files, which are stored in and accessible via the cloud, and confer ownership of that digital asset to an individual or entity. Alternatively, a digital asset may take the form of an entitlement token or credit (hereinafter “NFT credit”) issued to a consumer or other user as a reward for participating in a particular experience, such as consuming media content, participating in a game, attending a real-world event or locale, and the like.

An NFT credit is a unit of data stored on a secure digital database, such as a blockchain for example, that certifies the authenticity, and in some implementations, the valuation of the NFT credit. It is noted that, as defined in the present application, the term “NFT credit” may refer to any digital token conferring an entitlement to its owner and having ownership of the digital token certified by an NFT. Once awarded to a consumer, NFT credits may be spent in exchange for enhanced consumer experience, as further described below, or may be exchanged with other consumers, such as by being traded or sold, either directly with another consumer, or via an administered NFT credit marketplace.

It is further noted that, as defined in the present application the feature “multi-platform portable NFT credit” refers to a single NFT credit that may advantageously be redeemed by its owner for a variety of different experiences or experience enhancements, from a variety of different providers of those experiences. It is also noted that the term “digital wallet” may refer to a virtual account that stores the credentials of NFT credits (e.g., public and private keys, certifying ownership of the NFT credits), and enables an NFT credit owner to collect NFT credits, to spend credits, and to reassign. i.e., transfer ownership of NFT credits to another person or entity.

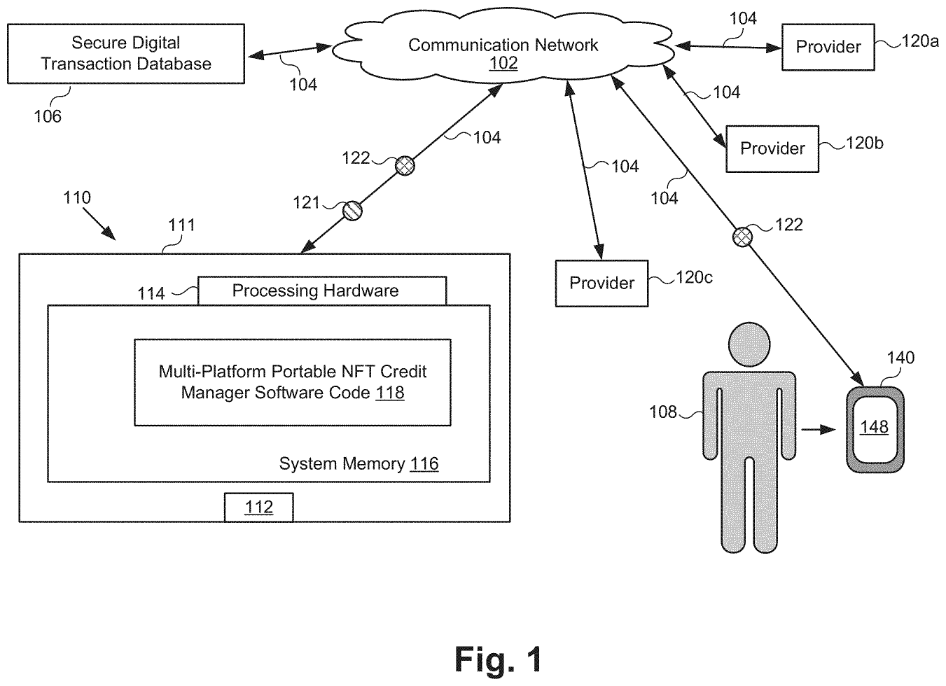

FIG. 1 shows a diagram including system 100 in the form of a multi-platform portable NFT credit source, according to one exemplary implementation. As shown in FIG. 1, system 110 includes computing platform 111 having transceiver 112, processing hardware 114, and system memory 116 implemented as a computer-readable non-transitory storage medium. According to the present exemplary implementation, system memory 116 stores multi-platform portable NFT credit manager software code 118. In addition. FIG. 1 shows consumer or user 108 (hereinafter “user 108”), user system 140 utilized by user 108 and having display 148, secure digital transaction database 106, content or experience providers 120a, 120b, and 120c, as well as communication network 102 and network communication links 104 communicatively coupling system 110 to user system 140, and secure digital transaction database 106 to system 110 and providers 120a, 120b, and 120c. Also shown in FIG. 1 are entitlement data 121 identifying user 108 and a right of user 108 to receive multi-platform portable NFT credit 122 redeemable by user 108 from any of providers 120a, 120b, and 120c.

With respect to the representation of system 110 shown in FIG. 1, it is noted that although multi-platform portable NFT credit manager software code 118 is depicted as being stored in system memory 116 for conceptual clarity, more generally, system memory 116 may take the form of any computer-readable non-transitory storage medium. The expression “computer-readable non-transitory storage medium,” as used in the present application, refers to any medium, excluding a carrier wave or other transitory signal that provides instructions to processing hardware of a computing platform, such as processing hardware 114 of computing platform 1l1. Thus, a computer-readable non-transitory storage medium may correspond to various types of media, such as volatile media and non-volatile media, for example. Volatile media may include dynamic memory, such as dynamic random access memory (dynamic RAM), while non-volatile memory may include optical, magnetic, or electrostatic storage devices. Common forms of computer-readable non-transitory storage media include, for example, optical discs, RAM, programmable read-only memory (PROM), erasable PROM (EPROM), and FLASH memory.

It is further noted that although FIG. 1 depicts multi-platform portable NFT credit manager software code 118 as being entirely located in a single instance of system memory 116, that representation is also merely provided as an aid to conceptual clarity. More generally, system 110 may include one or more computing platforms, such as computer servers for example, which may be co-located, or may form an interactively linked but distributed system, such as a cloud-based system, for instance. As a result, processing hardware 114 and system memory 116 may correspond to distributed processor and memory resources of system 110. Thus, it is to be understood that various software modules of multi-platform portable NFT credit manager software code 18 may be stored remotely from one another within the distributed memory resources of system 110.

Processing hardware 114 may include multiple hardware processing units, such as one or more central processing units, one or more graphics processing units, one or more tensor processing units, one or more field-programmable gate arrays (FPGAs), and an application programming interface (API) server, for example. By way of definition, as used in the present application, the terms “central processing unit” (CPU). “graphics processing unit” (GPU), and “tensor processing unit” (TPU) have their customary meaning in the art. That is to say, a CPU includes an Arithmetic Logic Unit (ALU) for carrying out the arithmetic and logical operations of computing platform 111, as well as a Control Unit (CU) for retrieving programs, such as multi-platform portable NFT credit manager software code 118, from system memory 116, while a GPU may be implemented to reduce the processing overhead of the CPU by performing computationally intensive graphics or other processing tasks. A TPU is an application-specific integrated circuit (ASIC) configured specifically for artificial intelligence (AI) applications such as machine learning modeling.

In some implementations, computing platform 111 may correspond to one or more web servers, accessible over a packet-switched network such as the Internet, for example. Alternatively, computing platform 111 may correspond to one or more computer servers supporting a private wide area network (WAN), local area network (LAN), or included in another type of limited distribution or private network. However, in some implementations, system 110 may be implemented virtually, such as in a data center. For example, in some implementations, system 110 may be implemented in software, or as virtual machines.

Transceiver 112 of system 110 may be implemented as any suitable wireless communication unit. For example, transceiver 112 may be implemented as a fourth generation (4G) wireless transceiver, or as a 5G wireless transceiver. In addition, or alternatively, transceiver 112 may be configured for communications using one or more of Wireless Fidelity (Wi-Fi), Worldwide Interoperability for Microwave Access (WiMAX), Bluetooth, Bluetooth low energy, ZigBee, radio-frequency identification (RFID), near-field communication (NFC), and 60 GHz wireless communications methods.

System 110 may be a creator or “minter” of multi-platform portable NFT credits, a minter and warehouse of multi-platform portable NFT credits, or a distributor or warehouse of multi-platform portable NFT credits created by others. Providers 120a, 120b, 120c are distinct providers of content or experiences. For example, providers 120a and 120b may be distinct streaming media platforms providing different content such that a subscription to provider 120a does not entitle a user to access content from providers 120b, and vice versa. By contrast, provider 120c may be a provider of real-world experiences at a physical venue. Examples of physical venues supported by provider 120c may include a theme park, cruise ship, destination resort, sports arena or stadium, cinema, or music venue, to name a few.

Secure digital transaction database 106 may take the form of a public or private secure digital transaction database. Examples of such secure digital transaction databases may include Blockchain. Hashgraph, Directed Acyclic Graph (DAG), and Holochain ledgers, to name a few. In use cases in which secure digital transaction database 106 is a blockchain, it may be advantageous or desirable to implement secure digital transaction database 106 to utilize a consensus mechanism having a proof-of-stake (PoS) protocol, rather than the more energy intensive proof-of-work (PoW) protocol. Although secure digital transaction database 106 is shown to be remote from system 110 in FIG. 1, such as a cloud-based or distributed secure digital transaction database, that implementation is merely exemplary. In other implementations, secure digital transaction database 106 may be stored in system memory 116 and may be controlled by system 110.

System 110 will be further described by reference to a specific and merely exemplary use case in which multi-platform portable NFT credit 122 serves as a gating token enabling user 108 to avoid viewing some or all advertisements (hereinafter “ads”) inserted into entertainment content provided as streaming content or broadcast content. By way of background, many consumers prefer not to consume ads as part of the consumption experience they desire, such as viewing movies or television (TV) content, listening to music content, or reading an electronic book (e-book), to name merely a few examples. The conventional solution for enabling user 108 to avoid exposure to ads is to require user 108 to pay a regular, fixed price service fee to gain access to an ad-free version of the content user 108 wishes to consume, or to subscribe to a separate service that is customized without ads. This requires provider 120a, for example, to determine a fair market price for the experience provider 120a is providing, and it requires user 108 to pay fixed rates periodically for a specific service or experience even as prices and services change. It also leaves provider 120a providing the subscription service at risk of losing subscribers and losing ad-revenue due to short-term fluctuations in the value of the content being delivered, and the value of the advertising market.

The novel and inventive solution disclosed by the present application addresses and overcomes the drawbacks in the conventional art through the use of multi-platform portable NFT credits. By issuing multi-platform portable NFT credits to user 108 based on an action or actions by user 108, such as consumption of content, ads, or content and ads, for example, the present solution enables user 108 to load a digital wallet with consumption credits (i.e., multi-platform portable NFT credits) that can be sold, traded, and purchased, either in a direct open market transaction with another user, or via an administered marketplace for NFT credits. Another consumer wishing to avoid ads can spend multi-platform portable NFT credits included in their own digital wallet to load a video player, physical card, or mobile application, for example, with multi-platform portable NFT credits that allow an ad-free or otherwise upgraded consumption experience.

The present solution advantageously allows users to obtain credits to last for various predetermined amounts of consumption time (e.g. one or more years' worth of multi-platform portable NFT credits purchased in advance at today's market prices). The present solution also advantageously enables users to consume content or perform another action and capture the value of that consumption or action by selling multi-platform portable NFT credits awarded in response to the consumption or action to other users. For example, where a first owner of a multi-platform portable NFT credit has an enhanced value (e.g., a value multiplier applied to it) as the result of an action by the first owner, that enhanced value is transferrable to a second owner upon assignment of the multi-platform portable NFT credit to the second owner. For example, a user who owns a multi-platform portable NFT credit acquired as the result of watching an episode of TV content, and that has had its valuation enhanced due to that user having subsequently watched the entire TV series including the episode, may be transferred to another user while retaining its enhanced valuation.

Moreover, in some implementations, the multi-platform portable NFT credit can be created with a market contract (hereinafter “smart contract”) that governs the use of the multi-platform portable NFT credits. In addition, or alternatively, such a smart contract may pay a royalty percentage of free-market sales back to the provider providing the experience for which multi-platform portable NFT credits were awarded when those multi-platform portable NFT credits are sold or traded in the future. Such a royalty system, combined with the pre-payment for future-use multi-platform portable NFT credits, advantageously create a secondary funding model for the provider providing the experience, as well as a passive revenue source that falls outside the short-term volatility of ad sales and subscription markets.

The structure of a multi-platform portable NFT credit can include wrapped metadata including key value pairs and allowing the multi-platform portable NFT credit to have flexible portability and valuation. For instance, consuming a video on “Platform A” of provider 120a could result in assignment of a multi-platform portable NFT credit with the following data:

“30 Second Ad-Sponsored Video Token”: {type: video, duration: 30, segment: Platform A, business: Provider 120a, product: 9999, advertiser: Ad Platform C, engagement type: viewed ad}

Alternatively, an interactive ad, deemed to have higher value can be marked with metadata to indicate a higher value:

“20 second interactive”: {type: video, duration: 30, segment: Platform A, business: Provider 120a, product: 9999, advertiser: Ad Platform C, engagement type: click-through ad}

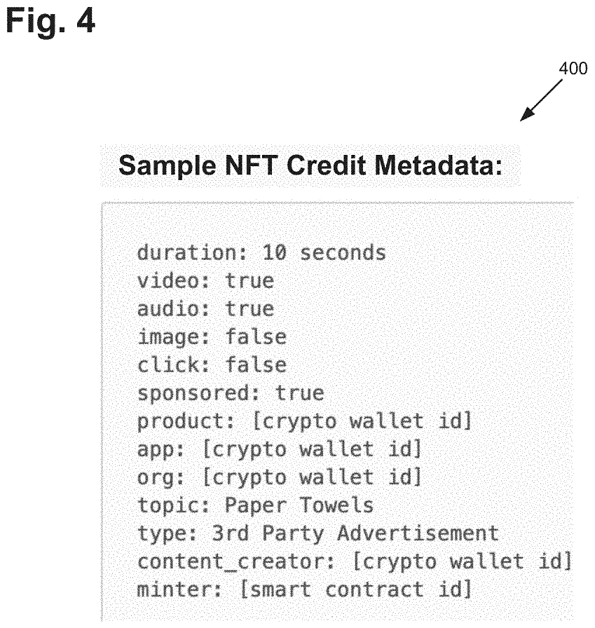

With respect to the specific instances of NFT credit metadata described above, it is noted that the representation of that metadata as pre-defined strings, such as text strings or time intervals, is merely exemplary. In other implementations, some or all of those metadata entries may take the form of Uniform Resource Identifiers (URIs), such as Universal Resource Locators (URLs) or Universal Resource Names (URNs), for example, as further described below by reference to FIG. 4. In yet other implementations, some or all of those metadata entries may take the form of universally unique identifiers (UUIDs), also sometimes referred to as globally unique identifiers (GUIDs) (hereinafter “UUIDs/GUIDs”).

The multi-platform portable NFT credits could be used as a value exchange for consuming ad-free content pertaining to either the product, upward to the segment, provider, or even across providers based on advertiser. The metadata and layering can be as simple or complex as needed for a particular product or experience. Nested metadata can also act as a value multiplier of a valuation associated with a multi-platform portable NFT credit. For example, redeeming the multi-platform portable NFT credit on a Platform A experience from provider 120a has a certain valuation, but using it on a Platform B experience from provider 120b has a higher value, and using it on the particular product (e.g., the 9999 product) may have an even higher value. It is noted that in secondary markets such as administered NFT marketplaces, multi-platform portable NFT credits can be traded with value multipliers based on their metadata.

Thus, in some use cases, a multi-platform portable NFT credit may be associated with one or more valuations based on which of providers 120a, 120b, or 120c the multi-platform portable NFT credit is redeemed from. In addition, or alternatively, a multi-platform portable NFT credit may be associated with one or more valuations based on how it is redeemed. For example, user 108 may interact with content that is or includes digital representations of persons, fictional characters, locations, objects, and identifiers such as brands and logos, for example, which populate a virtual reality (VR), augmented reality (AR), or mixed reality (MR) environment. Moreover, that content may depict virtual worlds that can be experienced by any number of users synchronously and persistently, while providing continuity of data such as personal identity, user history, entitlements, possessions, payments, and the like, or may be content that is a hybrid of traditional audio-video and fully immersive VR/AR/MR experiences, such as interactive video. In those use cases, a multi-platform portable NFT credit redeemed by user 108 while user 108 interacts with such content may have an increased valuation when compared to its redemption value while non-AR/VR/MR content is consumed by user 108.

An additional advantage of the present solution is that the provider providing a particular consumption experience, and advertisers, can gain new insights into consumer behaviors and preferences by observing market behaviors as every consumer has a unique digital wallet address, thereby providing a unique tracking ID in the form of the public key hash for the digital wallet. The digital wallet creates a reliable consumer identifier and provides information on advertising consumption, multi-platform portable NFT credit trading, and multi-platform portable NFT credit usage across various products and providers.

It is noted that the particular use case presented above is described with such specificity in the interests of conceptual clarity, and is not to be interpreted as limiting the present novel and inventive concepts. In other use cases, a multi-platform portable NFT credit or credits may entitle its owner to temporarily access content from a provider with which the owner does not have a subscription, or to have limited access to such content for a predetermined period of time.

Alternatively, in other use cases, a multi-platform portable NFT credit or credits may entitle its owner to preview a movie trailer or other audio-video, video, or audio content not yet available to the general public. That is to say, multi-platform portable NFT credit or credits may be redeemable by its owner (e.g., user 108) to access restricted content from one or more of providers 120a, 120b, and 120c (e.g., pay-per-view content, premier access content, and the like), or to unlock supplemental content (e.g., deleted scenes, bloopers, interviews with the cast/director, and the like). As yet another alternative, in some use cases, an NFT credit or credits may entitle its owner to an enhanced virtual or real-world experience at a physical venue, such as a theme park, cruise ship, destination resort, sports arena or stadium, cinema, or music venue, for example of one or more of providers 120a, 120b, and 120c.

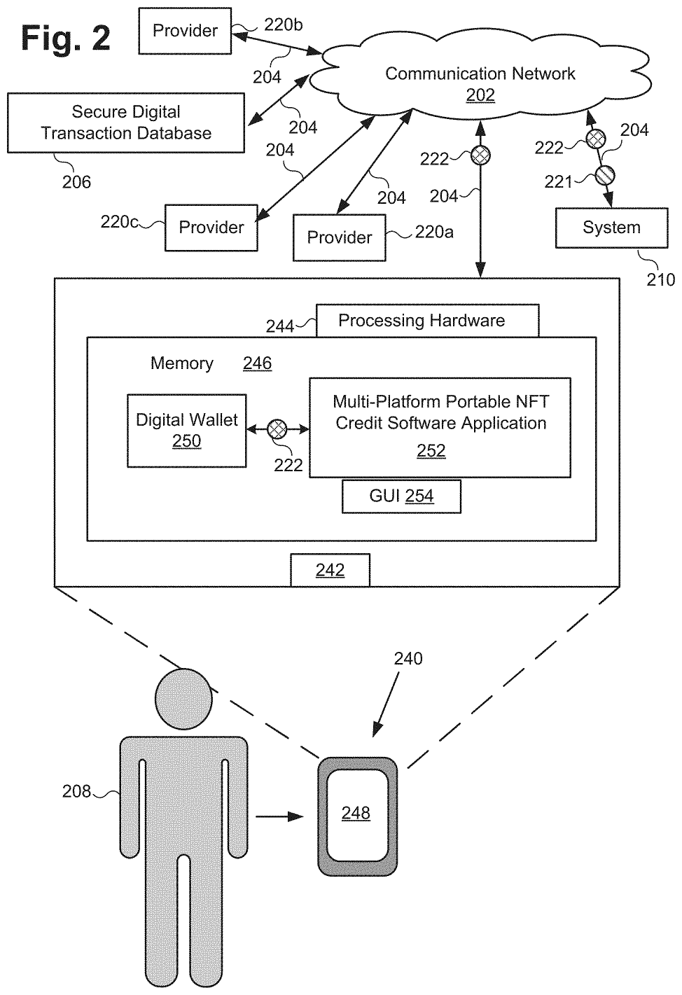

FIG. 2 shows user system 240 of user 208, configured to mediate collection, expenditure, and transfer of ownership of multi-platform portable NFT credit 222, according to one implementation. As shown in FIG. 2, user system 240 includes transceiver 242, processing hardware 244, display 248, and memory 246 implemented as a computer-readable non-transitory storage medium storing digital wallet 250 and multi-platform portable NFT credit software application 252 providing graphical user interface (GUI) 254. Also shown in FIG. 2 are system 210, communication network 202, network communication links 204, secure digital transaction database 206, entitlement data 221, and providers 220a, 220b, and 220c.

Although user system 240 is shown as a smartphone in FIG. 1 that representation is provided merely as an example as well. More generally, user system 240 may be any suitable mobile or stationary computing device or system that implements data processing capabilities sufficient to provide GUI 254, support connections to communication network 202, and implement the functionality ascribed to user system 240 herein. For example, in other implementations, user system 240 may take the form of a desktop computer, laptop computer, tablet computer, or smart TV, for example.

With respect to display 248 of user system 240, display 248 may be physically integrated with user system 240 or may be communicatively coupled to but physically separate from user system 240. For example, where user system 240 is implemented as a smartphone, laptop computer, or tablet computer, display 248 will typically be integrated with user system 240. By contrast, where user system 240 is implemented as a desktop computer, display 248 may take the form of a monitor separate from user system 240 in the form of a computer tower. Furthermore, display 248 of user system 240 may be implemented as a liquid crystal display (LCD), a light-emitting diode (LED) display, an organic light-emitting diode (OLED) display, a quantum dot (QD) display, or any other suitable display screen that performs a physical transformation of signals to light.

Multi-platform portable NFT credit software application 252 may be configured to initiate a secure and authorized communication session in order to receive multi-platform portable NFT credit 222, enable user 208 to spend multi-platform portable NFT credit 222 by providing inputs to GUI 254, or enable user 208 to transfer multi-platform portable NFT credit 222 to a digital wallet of another consumer by providing other inputs to GUI 254. It is noted that, in some implementations, multi-platform portable NFT credit software application 252 can be configured to spend multi-platform portable NFT credit 222 automatically, based on user selectable parameters such as type of content or experience, preferences of user 208, or on user selectable parameters and preferences of user 208. For instance, in the merely exemplary use case in which multi-platform portable NFT credit 222 is spent to skip an ad or ads gating access to segments of media content, multi-platform portable NFT credit 222 may be spent automatically based on the type of ad (e.g., auto vs. pharmaceutical), number of ads in an ad pod, or location relative to the timecode of the content the ad is inserted into, for example, thereby allowing an ad-integration to seamlessly and selectively bypass some or all ads when multi-platform portable NFT credits of appropriate value are present and spendable in digital wallet 250 of user 208.

According to the exemplary implementation shown in FIG. 2, digital wallet 250 can store multi-platform portable NFT credit 222 on user system 240. However, in other implementations, digital wallet 250 may not be resident on user system 240, but may be a digital wallet remote from user system 240, such as a cloud-based digital wallet accessible to user system 240 via communication network 202 and network communication links 204.

System 210, multi-platform portable NFT credit 222, communication network 202, network communication links 204, secure digital transaction database 206, entitlement data 221, and providers 220a, 220b, and 220c correspond respectively in general to system 110, multi-platform portable NFT credit 122, communication network 102, network communication links 104, secure digital transaction database 106, entitlement data 121, and providers 120a, 120b, and 120c in FIG. 1. Thus, system 210, multi-platform portable NFT credit 222, communication network 202, network communication links 204, secure digital transaction database 206, entitlement data 221, and providers 220a, 220b, and 220c may share any of the characteristics attributed to respective system 110, multi-platform portable NFT credit 122, communication network 102, network communication links 104, secure digital transaction database 106, entitlement data 121, and providers 120a, 120b, and 120c by the present disclosure, and vice versa.

Moreover, user 208 and user system 240, in FIG. 2, correspond respectively in general to user 108 and user system 140, in FIG. 1, and those corresponding features may share any of the characteristics attributed to either corresponding feature by the present disclosure. That is to say, although not shown in FIG. 1, in addition to display 148, user system 140 may include features corresponding respectively to transceiver 242, processing hardware 244, and memory 246 storing digital wallet 250 and multi-platform portable NFT credit software application 252 providing graphical user interface (GUI) 254.

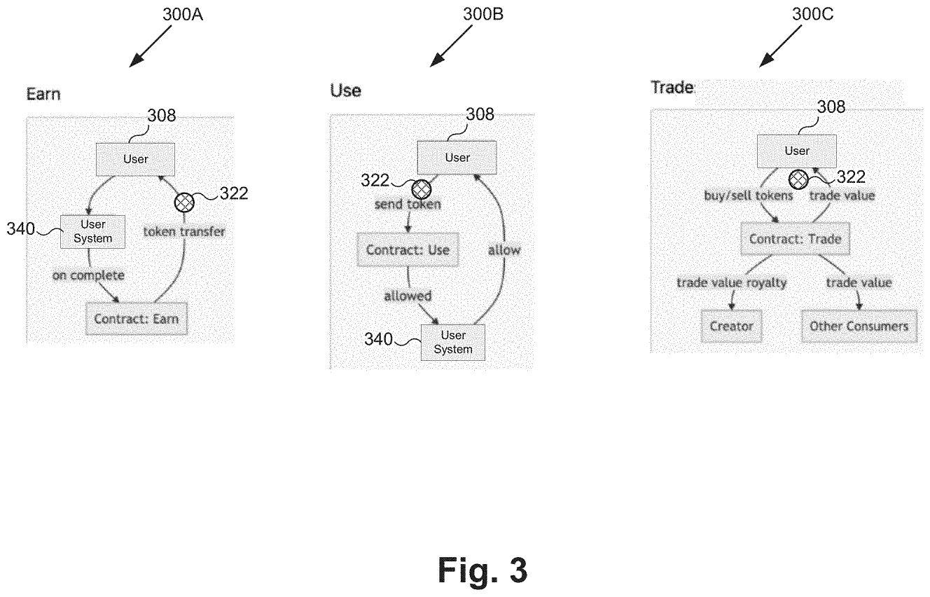

FIG. 3 shows three alternative scenarios in which user 308 can acquire and utilize multi-platform portable NFT credit 322. Also shown in FIG. 3 is user system 340. It is noted that user 308, user system 340, and multi-platform portable NFT credit 322 correspond respectively in general to user 108/208, user system 140/240, and multi-platform portable NFT credit 122/222 in FIGS. 1 and 2. Thus, user 308, user system 340, and multi-platform portable NFT credit 322 may share any of the characteristics attributed to respective user 108/208, user system 140/240 and multi-platform portable NFT credit 122/222 by the present disclosure, and vice versa.

As shown by scenario 300A in FIG. 3, in some instances user 308 may earn multi-platform portable NFT credit 322 by consuming content, such as entertainment content or entertainment content including ads, using user system 340. As further shown by scenario 300B, subsequent to earning multi-platform portable NFT credit 322, multi-platform portable NFT credit 322 can be loaded onto a media player of user system 340 from a digital wallet of user 308, either automatically or in response to inputs to user system 340 by user 308. Multi-platform portable NFT credit 322 may then be spent to enjoy ad-free, ad-reduced or an otherwise enhanced consumption experience of entertainment content using user system 340.

According to scenario 300C, user 308 may acquire or relinquish multi-platform portable NFT credit 322 via a market transaction, i.e., purchase, sale, or trade, with other consumers. In the case of a purchase, sale, or trade of a multi-platform portable NFT credit with other users, the creator or original provider of the multi-platform portable NFT credit may receive a royalty or royalties based on the sale value or trade value of the multi-platform portable NFT credit. It is noted that, in some implementations, royalties may be distributed upstream in a tiered manner based on metadata associated with the multi-platform portable NFT credit. That is to say, acquisition of an NFT credit by an end user may result in royalty distributions, each of which may be different, to one or more of a parent company of the entity that created the multi-platform portable NFT credit, that creative entity or a subsidiary of the parent company that includes the creative entity, and any intermediate distribution platforms or software applications, for example.

FIG. 4 shows table 400 of exemplary metadata included in a multi-platform portable NFT credit awarded for consuming an ad. As shown in FIG. 4, such metadata may include the time duration of the ad, whether the ad included video, audio, or an image, whether the ad was a click-through ad, whether the ad was sponsored, the application/platform/service providing the ad, the organization controlling the application/platform/service, the topic or subject matter of the ad, the type of ad, the content creator, and the minter of the NFT credit.

Although the metadata fields depicted in FIG. 4 are shown to be populated by pre-defined strings that representation is merely provided by way of example. In some implementations, as noted above, some or all of the metadata fields shown in FIG. 4 may be populated by a respective URI, such as a URL or URN, for example, or by a respective UUID/GUID. Potential advantages of using URIs or UUIDs/GUIDs rather than pre-defined strings include avoidance of metadata invalidation as language usage and the taxonomy of metadata tags evolves. In addition, use of URIs or UUIDs/GUIDs in place of pre-defined strings advantageously enables disambiguation between homonyms. Thus, in various implementations, NFT credit metadata fields corresponding in general to the metadata fields shown in FIG. 4 may include metadata in the form of specific time durations, pre-defined strings, URIs, UUIDs/GUIDs, or any combination thereof.

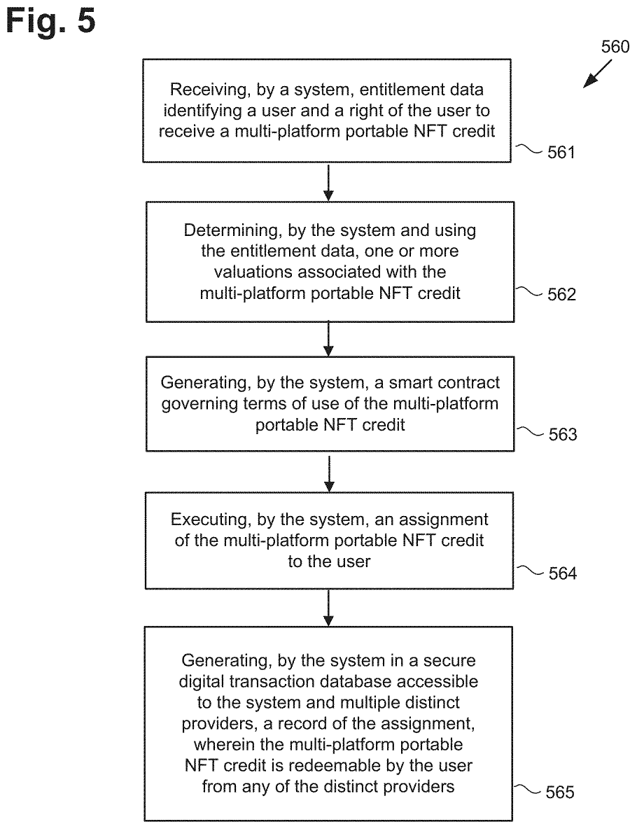

The functionality of system 100, in FIG. 1, will be further described by reference to FIG. 5. FIG. 5 shows flowchart 560 presenting an exemplary method for providing a multi-platform portable NFT credit to a user, according to one implementation. With respect to the method outlined in FIG. 5, it is noted that certain details and features have been left out of flowchart 560 in order not to obscure the discussion of the inventive features in the present application.

Referring to FIG. 5 in combination with FIGS. 1 and 2, flowchart 560 begins with receiving entitlement data 121/221 identifying user 108/208 and a right of user 108/208 to receive a multi-platform portable NFT credit (action 561). As shown in FIGS. 1 and 2, entitlement data 121/221 may be received by system 100/200, via communication network 102/202 and network communication links 104/204, using multi-platform portable NFT credit manager software code 118, executed by processing hardware 114.

In some use cases, entitlement data 121/221 may be received by system 100/200 in action 561 from user system 140/240 of user 108/208, and may identify user 108/208 as a purchaser, recipient in trade, or recipient by gift from another user, of multi-platform portable NFT credit 122/222. Alternatively, entitlement data 121/221 may be received by system 100/200 in action 561 from one or more of providers 120a/220a, 120b/220b, and 120c/220c, and may identify user 108/208 entitled to receive multi-platform portable NFT credit 122/222 based on an action by user 108/208, such as consumption of audio-video, audio, or video content, consumption of an ad or ad pod gating access to sections of such content, interaction with content in the form of digital representations that populate a virtual reality, augmented reality, or mixed reality environment, or attendance at a real-world location or event, for example.

Continuing to refer to FIGS. 1, 2, and 5 in combination flowchart 560 further includes determining, using entitlement data 121/221, one or more valuations associated with multi-platform portable NFT credit 122/222 (action 562). As noted above, multi-platform portable NFT credit 122/222 may have a default valuation, and may also have a value multiplier causing the valuation of multi-platform portable NFT credit 122/222 to vary based on how multi-platform portable NFT credit 122/222 is redeemed, from which of providers 120a/220a, 120b/220b, or 120c/220c multi-platform portable NFT credit 122/222 is redeemed, or based on both of those factors.

By way of example, where entitlement data 121/221 is received in action 561 from provider 120a/220a, entitlement data 121/221 may include metadata identifying a default value or base valuation of one credit unit if multi-platform portable NFT credit 122/222 is redeemed from either of providers 120b/220b or 120c/220c, but may include a value multiplier to increase the valuation to two credit units if multi-platform portable NFT credit 122/222 is redeemed from provider 120a/220a, thereby encouraging user 108/208 to remain loyal to products and services of provider 120a/220a. As another example, where entitlement data 121/221 is received in action 561 from provider 120b/220b, entitlement data 121/221 may include metadata identifying a default value or base valuation of one credit unit, but may include a value multiplier to increase the valuation to three credit units if multi-platform portable NFT credit 122/222 is redeemed while user 108/208 interacts with content in the form of digital representations that populate a virtual reality, augmented reality, or mixed reality environment.

Moreover, in various implementations, metadata included in entitlement data 121/221 may include multiple value multipliers applicable to a variety of redemptions scenarios for multi-platform portable NFT credit 122/222. Determination of the one or more valuations associated with multi-platform portable NFT credit 122/222 using entitlement data 121/221 may be performed in action 562 by multi-platform portable NFT credit manager software code 118, executed by processing hardware 114 of system 100/200.

Continuing to refer to FIGS. 1, 2, and 5 in combination, in some implementations, flowchart 560 may further include generating a smart contract governing terms of use of multi-platform portable NFT credit 122/222 (action 563). It is noted that action 563 is optional, and in some implementations may be omitted from the method outlined by flowchart 560. However, in some implementations it may be advantageous or desirable to impose terms of use on multi-platform portable NFT credit 122/222 in order to prevent or discourage fraud and abuse. By way of example, a term of use may cap the number of multi-platform portable NFT credits that can be earned during a specified period of time, such as twenty-four hours, for example, or any other specific time interval. Alternatively, or in addition, a term of use may limit the number of multi-platform portable NFT credits that can be redeemed during a specified period of time, or during a single online session.

With respect to the smart contract optionally generated in action 563, it is noted that in some implementations, such a smart contract may pay a royalty percentage of free-market sales back to the provider providing the experience for which multi-platform portable NFT credit 122/222 is awarded when multi-platform portable NFT credit 122/222 is sold or traded in the future. As noted above, such a royalty system, combined with the pre-payment for future-use multi-platform portable NFT credits, advantageously create a secondary funding model for the provider providing the experience, as well as a passive revenue source that falls outside the short-term volatility of ad sales and subscription markets. In implementations in which the method outlined by flowchart 560 includes action 563, action 563 may be performed by multi-platform portable NFT credit manager software code 118, executed by processing hardware 114 of system 100/200.

Continuing to refer to FIGS. 1, 2, and 5 in combination flowchart 560 further includes executing an assignment of multi-platform portable NFT credit 122/222 to user 108/208 (action 564). Action 564 may be performed by multi-platform portable NFT credit manager software code 118, executed by processing hardware 114 of system 100/200.

In some implementations, as shown by FIGS. 1 and 2, assignment of multi-platform portable NFT credit 122/222 to user 108/208 transfers multi-platform portable NFT credit 122/222 to digital wallet 250 of user 108/208, thereby giving user 108/208 substantially unfettered control over multi-platform portable NFT credit 122/222. However, in other implementations it may be advantageous or desirable to institute a mechanism for enforcing terms of use of multi-platform portable NFT credit 122/222. For example, in implementations in which action 563 is performed to generate a smart contract governing the terms of use of multi-platform portable NFT credit 122/222, assignment of multi-platform portable NFT credit 122/222 may transfer metadata enabling user 108/208 to redeem multi-platform portable NFT credit 122/222 from a digital wallet maintained by system 100/200 on behalf of user 108/208. In those latter implementations, system 100/200 may retain the right, after assignment of multi-platform portable NFT credit 122/222 to user 108/208, to revoke multi-platform portable NFT credit 122/222 if the terms of use are violated.

Continuing to refer to FIGS. 1, 2, and 5 in combination flowchart 560 further includes generating, in secure digital transaction database 106/206 accessible to system 100/200 and providers 120a/220a, 120b/220b, and 120c/220c, a record of the assignment performed in action 564 (action 565). It is emphasized that one of the distinct advantages of being assigned multi-platform portable NFT credit 122/222, is that multi-platform portable NFT credit 122/222 is redeemable by user 108/208 from any of providers 120a/220a, 120b/220b, or 120c/220c. Action 565 may be performed by multi-platform portable NFT credit manager software code 118, executed by processing hardware 114 of system 100/200.

It is noted that although flowchart 560 lists action 565 as following action 564, that representation is merely exemplary. In various implementations, action 565 may follow action 564 or may be performed in parallel with, i.e., contemporaneously with, action 564. Furthermore, with respect to the actions described by flowchart 560, it is further noted that actions 561, 562, 564, and 565, or actions 561, 562, 563, 564, and 565, may be performed in an automated process from which human involvement may be omitted.

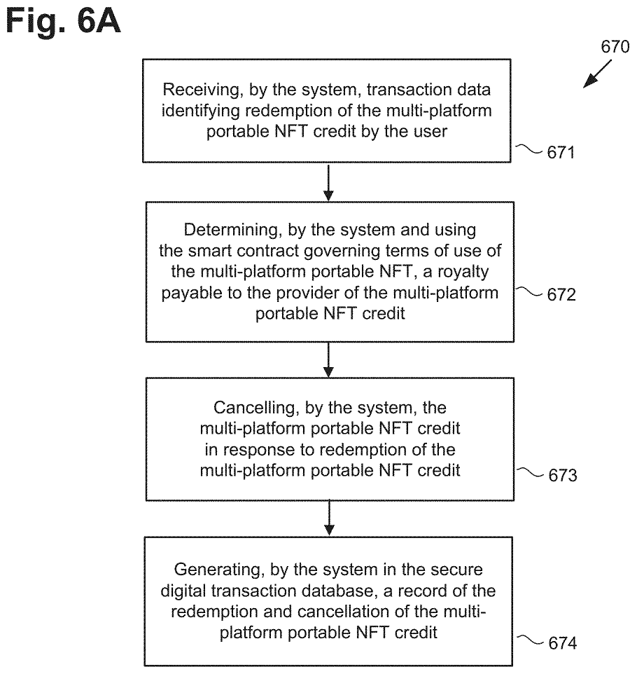

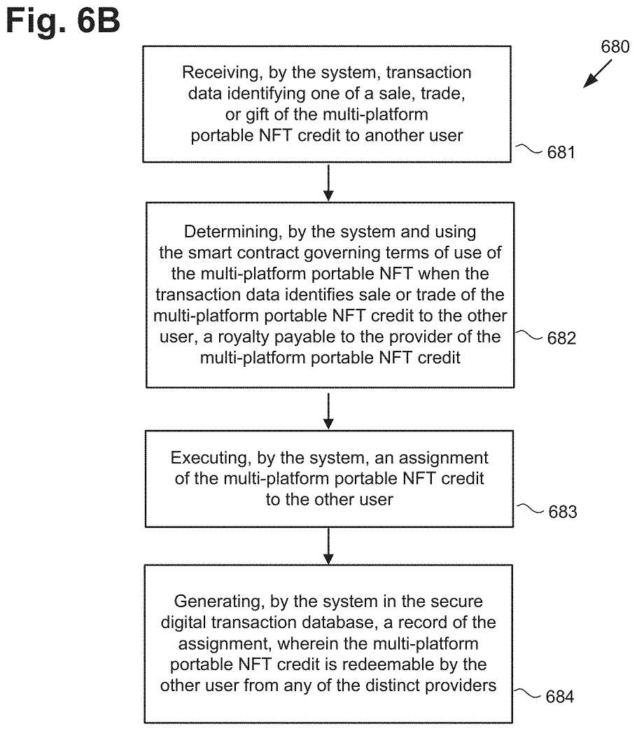

The functionality of system 100, in FIG. 1, will be still further described by reference to FIGS. 6A and 6B. FIG. 6A shows flowchart 670 presenting an exemplary method surrounding redemption of a multi-platform portable NFT credit by a user, according to one implementation, while FIG. 6B shows flowchart 680 presenting an exemplary method surrounding transfer by sale, trade, or gift of a multi-platform portable NFT credit to another user, according to one implementation. With respect to the methods outlined in FIGS. 6A and 6B, it is noted that certain details and features have been left out of flowcharts 670 and 680 in order not to obscure the discussion of the inventive features in the present application.

Referring to FIG. 6A, flowchart 670 begins with receiving transaction data identifying redemption of multi-platform portable NFT credit 122/222 by user 108/208 (action 671). The transaction data may be received by system 100/200 from one of providers 120a/220a, 120b/220b, or 120c/220c, via communication network 102/202 and network communication links 104/204, using multi-platform portable NFT credit manager software code 118, executed by processing hardware 114.

In implementations in which a smart contract governing terms of use of multi-platform portable NFT credit 122/222 was generated in action 563, flowchart 670 further includes determining, using the smart contract, a royalty payable to the provider of multi-platform portable NFT credit 122/222 (action 672). Determination of the royalty payable to the provider of multi-platform portable NFT credit 122/222 may be performed by multi-platform portable NFT credit manager software code 118, executed by processing hardware 114.

With respect to the smart contract optionally generated in action 563 and utilized in action 672, it is noted that in some implementations, such a smart contract may pay a royalty percentage back to the provider providing the experience for which multi-platform portable NFT credit 122/222 is awarded when multi-platform portable NFT credit 122/222 is redeemed. As noted above, such a royalty system, combined with the pre-payment for future-use multi-platform portable NFT credits, advantageously create a secondary funding model for the provider providing the experience, as well as a passive revenue source that falls outside the short-term volatility of ad sales and subscription markets.

Flowchart 670 further includes cancelling multi-platform portable NFT credit 122/222 in response to the redemption of multi-platform portable NFT credit 122/222 (action 673). Action 673 may be performed by multi-platform portable NFT credit manager software code 118, executed by processing hardware 114 of system 100/200.

Flowchart further includes generating, in secure digital transaction database 106/206 accessible to system 100/200 and providers 120a/220a, 120b/220b, and 120c/220c, a record of the redemption and cancellation of multi-platform portable NFT credit 122/222 (action 674). Action 674 may be performed by multi-platform portable NFT credit manager software code 118, executed by processing hardware 114 of system 100/200.

It is noted that although flowchart 670 lists action 674 as following action 673, that representation is merely exemplary. In various implementations, action 674 may follow action 673 or may be performed in parallel with, i.e., contemporaneously with, action 673.

Referring to FIG. 6B, flowchart 680 begins with receiving transaction data identifying one of a sale, trade, or gift of multi-platform portable NFT credit 122/222 to another user (action 681). The transaction data may be received by system 100/200 from user 108/208 via communication network 102/202 and network communication links 104/204, using multi-platform portable NFT credit manager software code 118, executed by processing hardware 114.

In implementations in which a smart contract governing terms of use of multi-platform portable NFT credit 122/222 was generated in action 563, flowchart 680 further includes determining, using the smart contract when the transaction data identifies sale or trade of multi-platform portable NFT credit 122/222, a royalty payable to the provider of multi-platform portable NFT credit 122/222 (action 682). Such a royalty may be determined using the smart contract based on the sale price or value received in trade for multi-platform portable NFT credit 122/222. Determination of the royalty payable to the provider of multi-platform portable NFT credit 122/222, in action 682, may be performed by multi-platform portable NFT credit manager software code 118, executed by processing hardware 114.

With respect to the smart contract optionally generated in action 563 and utilized in action 682, it is noted that in some implementations, such a smart contract may pay a royalty percentage of free-market sales back to the provider providing the experience for which multi-platform portable NFT credit 122/222 is awarded when multi-platform portable NFT credit 122/222 is sold or traded. As noted above, such a royalty system, combined with the pre-payment for future-use multi-platform portable NFT credits, advantageously create a secondary funding model for the provider providing the experience, as well as a passive revenue source that falls outside the short-term volatility of ad sales and subscription markets.

Flowchart 680 further includes executing an assignment of multi-platform portable NFT credit 122/222 to the other user (action 683). Action 683 may be performed by multi-platform portable NFT credit manager software code 118, executed by processing hardware 114 of system 100/200.

Flowchart 680 further includes generating, in secure digital transaction database 106/206, a record of the assignment performed in action 683 (action 684). It is emphasized that one of the distinct advantages of being assigned multi-platform portable NFT credit 122/222, is that multi-platform portable NFT credit 122/222 is redeemable by the other user from any of providers 120a/220a, 120b/220b, or 120c/220c. Action 684 may be performed by multi-platform portable NFT credit manager software code 118, executed by processing hardware 114 of system 100/200.

It is noted that although flowchart 680 lists action 684 as following action 683, that representation is merely exemplary. In various implementations, action 684 may follow action 683 or may be performed in parallel with, i.e., contemporaneously with, action 683.

With respect to the actions described by flowcharts 670 and 680, it is noted that actions 671, 673, and 674, or actions 671, 672, 673, and 674, or actions 681, 683, and 684 or actions 681, 682, 683, and 684 may be performed in an automated process from which human involvement may be omitted.

Thus, the present application discloses systems and methods enabling the acquisition and use of multi-platform portable NFT credits. The solutions disclosed in the present application advantageously advance the state-of-the-art in several distinct ways, including creating a new unique identifier for consumers, in the form of a digital wallet public key hash, and creating new markets underneath platforms and services providing consumable experiences (e.g. “minutes of Platform A of provider 120a without ads”, “minutes of Platform B of provider 120b”. “Platform B web page loads without ads”, “video minutes of Programming Content X without ads”, and the like). In addition, in the realm of advertising analytics, the solutions disclosed in the present application advantageously allow new data collection to understand which consumers are willing to consume ads for other users and which users are willing to buy ad consumption credits from others, as well as to provide insights into which ad topics or ad types tend to be skipped versus those that tend to be consumed. Moreover, the solutions disclosed in the present application enable consumers to pre-purchase large volumes of consumable credits ensuring future access to restricted or upgraded experiences at present day prices, while creating an alternate funding source for platforms and services providing consumable experiences.

From the above description it is manifest that various techniques can be used for implementing the concepts described in the present application without departing from the scope of those concepts. Moreover, while the concepts have been described with specific reference to certain implementations, a person of ordinary skill in the art would recognize that changes can be made in form and detail without departing from the scope of those concepts. As such, the described implementations are to be considered in all respects as illustrative and not restrictive. It should also be understood that the present application is not limited to the particular implementations described herein, but many rearrangements, modifications, and substitutions are possible without departing from the scope of the present disclosure.

What is claimed is:

1. A system comprising:
a computing platform including processing hardware and a system memory storing a software code:
the processing hardware configured to execute the software code to:
receive entitlement data identifying a user and a right of the user to receive a multi-platform portable non-fungible token (NFT) credit;
determine, using the entitlement data, one or more valuations associated with the multi-platform portable NFT credit;
execute an assignment of the multi-platform portable NFT credit to the user, and
generate, in a secure digital transaction database accessible to the system and a plurality of distinct providers, a record of the assignment;
wherein the multi-platform portable NFT credit is redeemable by the user from any of the plurality of distinct providers.

2. The system of claim 1, wherein the one or more valuations associated with the multi-platform portable NFT credit varies depending upon which of the plurality of distinct providers the multi-platform portable NFT credit is redeemed from.

3. The system of claim 1, wherein the one or more valuations associated with the multi-platform portable NFT credit varies depending upon how the multi-platform portable NFT credit is redeemed.

4. The system of claim 3, wherein the multi-platform portable NFT credit is redeemed by the user while the user interacts with content comprising digital representations that populate a virtual reality, augmented reality, or mixed reality environment.

5. The system of claim 1, wherein the assignment of the multi-platform portable NFT credit transfers the multi-platform portable NFT credit to a digital wallet of the user.

6. The system of claim 1, wherein the processing hardware is further configured to execute the software code to:
generate a smart contract governing terms of use of the multi-platform portable NFT credit; and
wherein the assignment of the multi-platform portable NFT credit transfers metadata enabling the user to redeem the multi-platform portable NFT credit from a digital wallet maintained by the system on behalf of the user.

7. The system of claim 6, wherein the system retains the right, after assignment of the multi-platform portable NFT credit, to revoke the multi-platform portable NFT credit if the terms of use are violated.

8. The system of claim 1, wherein the multi-platform portable NFT credit is redeemable by the user to access restricted content from one or more of the plurality of distinct providers.

9. The system of claim 1, wherein the multi-platform portable NFT credit is redeemable by the user to access a real-world experience from one or more of the plurality of distinct providers.

10. The system of claim 1, wherein the user is a first user, and wherein an enhanced value of the multi-platform portable NFT credit resulting from an action by the first user is transferable to a second user.

11. A method for use by a system including a computing platform having a processing hardware and a system memory storing a software code, the method comprising:
receiving, by the software code executed by the processing hardware, entitlement data identifying a user and a right of the user to receive a multi-platform portable NFT credit;
determining, by the software code executed by the processing hardware and using the entitlement data, one or more valuations associated with the multi-platform portable NFT credit;
executing, by the software code executed by the processing hardware, an assignment of the multi-platform portable NFT credit to the user, and
generating, by the software code executed by the processing hardware, in a secure digital transaction database accessible to the system and a plurality of distinct providers, a record of the assignment;
wherein the multi-platform portable NFT credit is redeemable by the user from any of the plurality of distinct providers.

12. The method of claim 11, wherein the one or more valuations associated with the multi-platform portable NFT credit varies depending upon which of the plurality of distinct providers the multi-platform portable NFT credit is redeemed from.

13. The method of claim 11, wherein the one or more valuations associated with the multi-platform portable NFT credit varies depending upon how the multi-platform portable NFT credit is redeemed.

14. The method of claim 13, wherein the multi-platform portable NFT credit is redeemed by the user while the user interacts with content comprising digital representations that populate a virtual reality, augmented reality, or mixed reality environment.

15. The method of claim 11, wherein the assignment of the multi-platform portable NFT credit transfers the multi-platform portable NFT credit to a digital wallet of the user.

16. The method of claim 11, further comprising:
generating, by the software code executed by the processing hardware, a smart contract governing terms of use of the multi-platform portable NFT credit; and
wherein the assignment of the multi-platform portable NFT credit transfers metadata enabling the user to redeem the multi-platform portable NFT credit from a digital wallet maintained by the system on behalf of the user.

17. The method of claim 16, wherein the system retains the right, after assignment of the multi-platform portable NFT credit, to revoke the multi-platform portable NFT credit if the terms of use are violated.

18. The method of claim 11, wherein the multi-platform portable NFT credit is redeemable by the user to access restricted content from one or more of the plurality of distinct providers.

19. The method of claim 11, wherein the multi-platform portable NFT credit is redeemable by the user to access a real-world experience from one or more of the plurality of distinct providers.

20. The method of claim 11, wherein the user is a first user, and wherein an enhanced value of the multi-platform portable NFT credit resulting from an action by the first user is transferable to a second user.
